(19) United States
(12) Patent Application Publication
(10) Pub. No.: US 2014/0157276 A1
(43) Pub. Date: Jun. 5, 2014

(54) DISTRIBUTED TRANSACTION ROUTING

(71) Applicant: International Business Machines Corporation, Armonk, NY (US)

(72) Inventor: Andrew N. Smithson, Winchester (GB)

(73) Assignee: International Business Machines Corporation, Armonk, NY (US)

(21) Appl. No.: 14/073,989

(22) Filed: Nov. 7, 2013

(30) Foreign Application Priority Data
Dec. 5, 2012 (GB) 1221871.5

(51) Int. Cl. G06F 9/46

(52) U.S. Cl. CPC G06F 9/466
USPC 718/101

(57) ABSTRACT

Embodiments relate to routing a distributed transaction. An aspect includes receiving and storing distributed transaction initiation information from a transaction manager. Another aspect includes sending an okay message to the transaction manager. Another aspect includes receiving a distributed transaction having at least one function type from the transaction manager. Another aspect includes determining a resource manager for the distributed transaction based on the function type of the distributed transaction. Another aspect includes sending, based on the resource manager being ready, the distributed transaction to the determined resource manager.

### PRIORITY

This application claims priority to Great Britain Patent Application No. GB 1221871.5, filed Dec. 5, 2012, and all the benefits accruing therefrom under 35 U.S.C. §119, the contents of which in its entirety are herein incorporated by reference.

### BACKGROUND

The present disclosure relates generally to distributed transaction computing, and more specifically to routing transactions in a distributed transaction processing environment.

Computer networks are capable of performing jobs that no single computer could perform and they allow low cost personal computer systems to connect to larger systems to perform tasks that such low cost systems could not perform alone. In order for computer systems to cooperate in a network to perform a complex task, software must be developed which efficiently delegates parts of the task to different computers in the network.

The International Standards Organization (ISO) has defined an ISO Distributed Transaction Processing (DTP) standard to support the synchronization and co-ordination of distributed applications to ensure that transactions can be completed reliably on multiple open systems. X/Open is an industrial standards organization that has defined a reference module for the OSI DTP. X/Open has also defined application program interfaces and system interfaces between system components defined in the model.

The X/Open model defines the various system elements that work together to perform distributed transaction processing. In particular, the X/Open model defines transaction managers (TMs) and resource managers (RMs) that work together, along with other elements, to facilitate distributed processing. Transaction managers are the components that assign identifiers to transactions, monitor the progress of transactions, and take responsibility for transaction completion and coordinating failure recovery. Resource managers are the components that provide access to resources, such as database systems. Typically, the transaction manger coordinates the start and finish of global transactions of each participating resource manager. For example, when an application calls the transaction manager to start a global transaction, the transaction manager assigns a global transaction ID and informs the resource manager about the new transaction branch. After the application performs operations on the resource manager within the global transaction, the transaction manager calls the resource manager to either commit or rollback the transaction branch. Also, if failure recovery is needed the transaction manager recalls the failed transaction from the resource manager and continues to complete the failed transaction.

In order for transaction managers and resource managers to work together to facilitate distributed processing, the X/Open model requires that all resource managers register to the transaction manager before the distributed transaction begins. This registration makes the resource manager known to the transaction manager, such that they can work together to complete transactions.

Extended Architecture (XA) is an X/Open group standard for executing a global transaction that accesses more than one back-end data-store. XA specifies how a transaction manager can roll up the transactions against the different data-stores into an “atomic” transaction and execute this with the two-phase commit protocol for the transaction.

### BRIEF SUMMARY

A system, method, and computer program product for routing a distributed transaction are provided. An aspect includes receiving and storing distributed transaction initiation information from a transaction manager. Another aspect includes sending an okay message to the transaction manager. Another aspect includes receiving a distributed transaction having at least one function type from the transaction manager. Another aspect includes determining a resource manager for the distributed transaction based on the function type of the distributed transaction. Another aspect includes sending, based on the resource manager being ready, the distributed transaction to the determined resource manager.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

Various embodiments will now be described, by way of example only, with reference to the following drawings in which:

FIG. 1A is a schematic block diagram of a prior art X/Open system;

FIG. 1B is a schematic block diagram of the X/Open system according to an embodiment;

FIG. 1C is a deployment diagram according to an embodiment;

FIG. 2 is a component diagram according to an embodiment;

FIG. 3 is a flow diagram of a process according to an embodiment;

FIG. 4 is a flow diagram of a second process according to an embodiment; and

FIG. 5A to 5G are examples of a transaction manager routing a transaction to a resource manager according to various embodiments.

### DETAILED DESCRIPTION

Embodiments disclosed herein related to distributed transaction processing. Embodiments allow an XA protocol distributed transaction environment to route transactions to different resources based on dynamic algorithms using the information about what the transaction is going to do. The embodiments were developed in line with International Standards Organization (ISO) Distributed Transaction Processing (DTP) standards, and in particular in the X/Open defined reference model for the ISO DTP. There are three main components in the X/Open Distributed Transaction Processing model: application programs, resource managers, and transaction managers. In X/Open systems, these three elements work together to assure consistent execution of transactions in distributed processing systems.

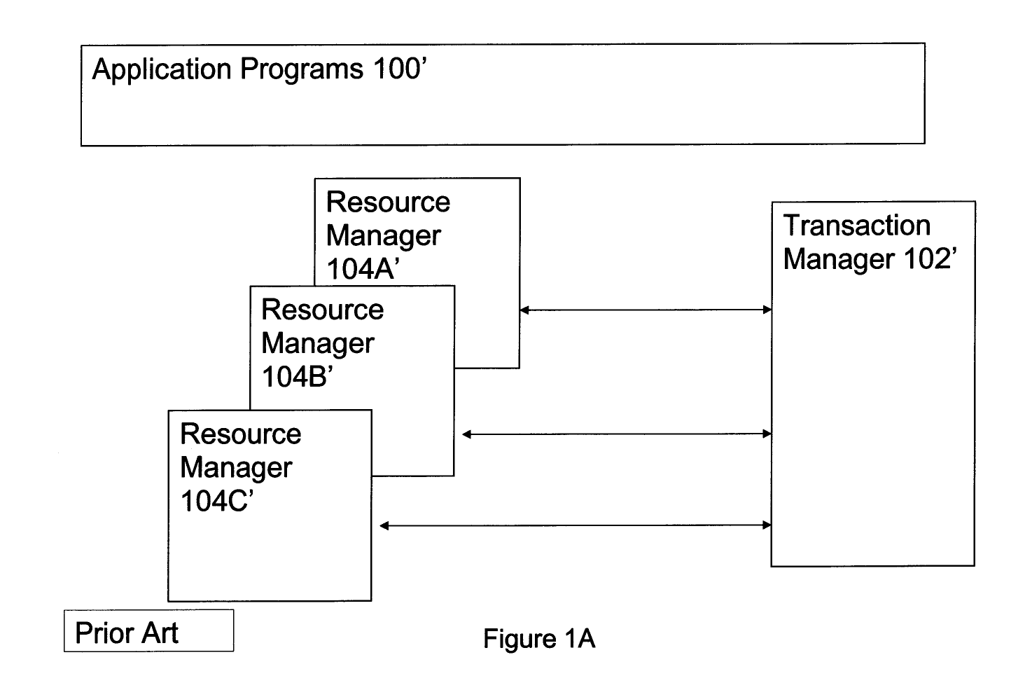

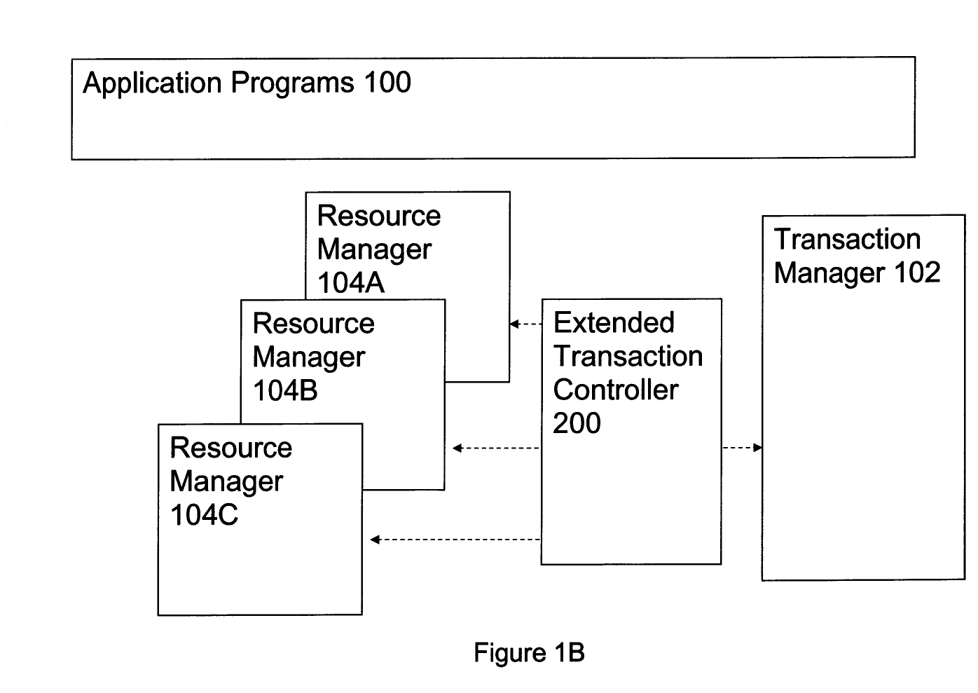

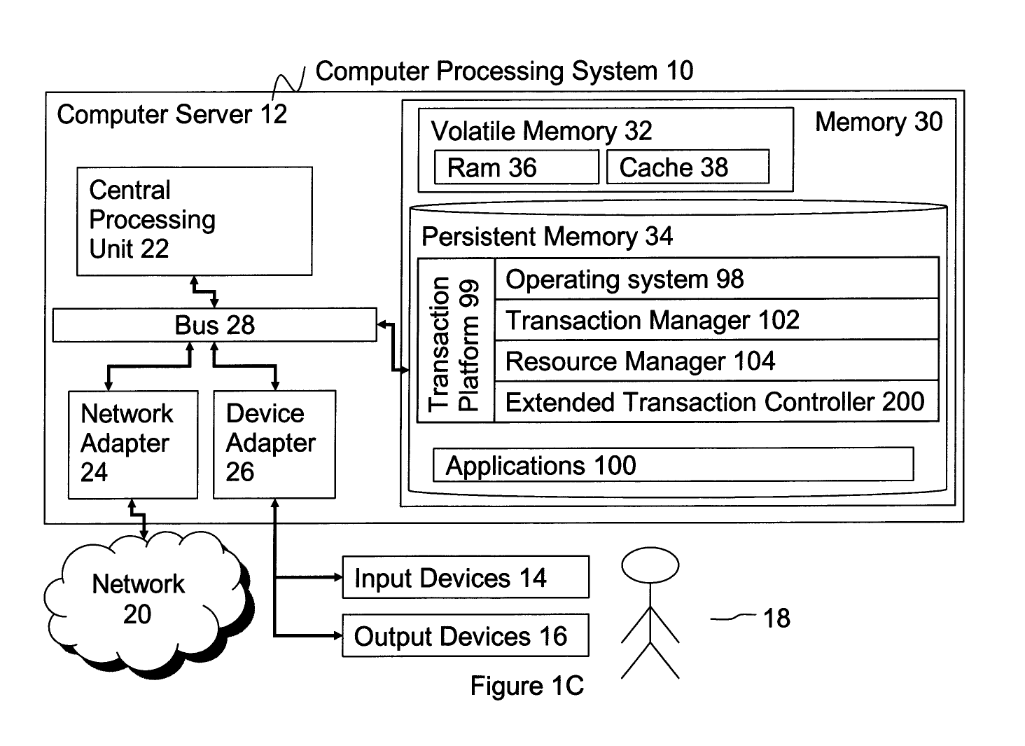

Referring to FIG. 1A, application programs 100′, transaction manager 102′ and resource managers 104A′, 104B′ and 104C′ are illustrated schematically as they would interact in a prior art X/Open system. In an X/Open system, the application program specifies and orders the actions that constitute the transactions. Resource Managers 104A′, 104B′ and 104C′ provide access to shared resources such as databases. Transaction manager 102′ assigns identifiers to transactions, monitors their programs, and takes responsibility for transaction completion and for failure recovery. Some elements from an X/Open system that are not directly involved in various embodiments are not illustrated, such as communication managers.

The X/Open model defines the interfaces between the application programs, transaction managers, and resource managers. Application programs communicate with the transaction manager to delimit transactions. The transaction manager provides the application with API calls to inform it of the start, end and disposition of transactions. The application program communicates with the resource manager directly to perform useful work.

In X/Open systems, the transaction manager and resource manager communicate using what is referred to as the XA interface (not shown). The XA interface follows a designed specification which describes the protocol for transaction coordination, commitment and recovery. The XA interface implements a two phase commit protocol.

A transaction comprises a collection of operations on the physical and abstract application state. Transactions may include reading or modifying data resources involved in the transaction. In that regard, a distributed transaction refers to a transaction involving data resources throughout a distributed environment.

In X/Open terminology, “global transactions” are transactions that involve resource managers that are known to the transaction manager and are under the transaction manager's two phase commit control. A global transaction is thus a unit of work that could involve one or more resource managers. A transaction branch is part of the work between a transaction manager and a resource manager to support the global transaction. A global transaction could have multiple transaction branches when multiple resource managers are accessed through one or more application processes that are coordinated by the transaction manager. Global transactions are coordinated by the transaction manager, with each application process having its own transaction branch with a resource manager. The transaction manager assigns transaction identifiers (known as XIDs) to identify the global transaction and the specific transaction within a resource manager.

A transaction begins when an application program initiates a requested transaction. This is done by the application program issuing a Begin Transaction ( ) request to the transaction manager. The transaction ends with either a commit or rollback operation coordinated by the transaction manager. A commit operation successfully completes the transaction, while a rollback operation terminates the transaction without completion and returns the resources to the pre-transaction state due to abnormal circumstances.

The commit and rollback operations are employed to ensure that the transaction has atomic, consistent, isolated, and durable (ACID) properties. Atomicity means that changes to the state of resources will either all occur or none of them will occur. Accordingly, a transaction either succeeds or fails. If it succeeds, the results of the transaction are committed and made permanent. On the other hand, if the transaction fails, all effects of the unsuccessful transaction are undone. Consistency means that a transaction is a correct transformation of state. Isolated means that transactions cannot interfere with one another. Finally, durability ensures that once a transaction completes successfully (i.e. commits) its change to the state of the resource survives failures to the system.

The X/Open distributed processing protocol uses the previously discussed two phase commit procedure as the primary mechanism to enforce ACID properties on transactions. In particular, a transaction manager includes recovery procedures that maintain the ACID nature of transactions and re-establish system operation after failure. Furthermore, a transaction manager that first receives the application's request to begin a transaction is given primary responsibility for managing the transaction.

A transaction may occur either on a single computer system independently, or on a distributed basis on multiple systems. A distributed transaction may cause changes to be made at one or more sites. In such a system, atomicity can be guaranteed only if all of the sites involved in the transaction agree on its outcome. As described in the above-referenced transaction processing textbook, distributed transaction systems can use a transaction synchronization procedure called two-phase commit protocol to guarantee the ACID properties of the transaction.

There follows an example for illustrating the two-phase commit protocol. When a transaction ends successfully at a site executing such a two-phase commit protocol, the transaction manager requests that all resource managers commit or make permanent all data operations involved in the transaction. In the first phase of the protocol, the resource managers are requested to prepare to commit. Typically, this is done by calling the xa_end( ) and xa_prepare( ) commands on all the resources managers.

In response, each resource manager individually decides whether, based upon local conditions, it can commit the transaction. Each resource manager then “votes”, telling the transaction manager whether it can commit or it must rollback.

In the second phase, if all votes are to commit, a request to commit is issued by the transaction manager, typically by calling an xa_commit( ) command on the resource managers. In response to the xa_commit( ) command, the resource managers commit their respective operation on the resource. If on the other hand, any sites have voted to rollback, a request to rollback is issued by the transaction manager, typically by calling an xa_rollback( ) command. In response to the rollback command, the resource managers rollback their respective operation, returning the resources to their position before the transaction started. Thus, the two-phase commit protocol is used to ensure that the ACID properties of the transaction are maintained in a distributed system.

An X/Open system may use several threads to execute a single transaction. The xa_start( ) and xa_end( ) commands are called on the resource manager by the transaction manager. The commands pass an identification used to associate or dissociate the calling thread with the transaction branch. The primary function of the xa_start( ) command is to register a new transaction branch with the called resource manager. Then a thread is actively associated with a transaction branch if it has called xa_start( ) and has not made a corresponding call to xa_end( ).

Subsequently, the application program, using the same thread of control, uses the resource manager's native interface to its work. All requests for service made by the same thread are part of the same branch until the thread dissociates from the branch. Another use of the xa_start( ) command is to join an existing transaction branch that has been suspended.

The xa_end( ) dissociates the calling thread from the transaction branch and lets the branch be completed. Another form of xa_end( ) suspends, instead of ending, a thread's association with the transaction. By using the resume form of xa_start( ), it or another thread can resume its associations with the transaction.

Referring to FIG. 1B, application programs 100, transaction manager 102, resource managers (104A, 104B 104C); and extended transaction controller 200 are illustrated schematically as they would interact in the embodiments of X/Open system. In some embodiments, extended transaction controller 200 introduces extra transaction processing between a transaction manager 102 and resource managers (104A, 104B, 104C) so that resource managers can be better matched to transactions for more efficient operation of the distributed transaction system.

Referring to FIG. 1C, the deployment of an embodiment in computer processing system 10 is described. Computer processing system 10 is one computer system operational with numerous other general purpose or special purpose computing system environments or configurations. In some embodiments, separate computer processing systems would host a transaction manager as a transaction platform, an extended transaction controller as a transaction platform, and resource managers as transaction platforms. Therefore a generic computer processing system is described that can be adapted to any one of the components of the distributed transaction system of some embodiments. Examples of well-known computing processing systems, environments, and/or configurations that may be suitable for use with computer processing system 10 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer processing system 10 may be described in the general context of computer system-executable instructions, such as program modules, being executed by a computer processor. Generally, program modules may include routines, programs, objects, components, logic, and data structures that perform particular tasks or implement particular abstract data types.

Computer processing system 10 may be embodied in distributed cloud computing environments where tasks are performed by remote processing devices that are linked through a communications network. In a distributed cloud computing environment, program modules may be located in both local and remote computer system storage media including memory storage devices. Computer processing system 10 comprises: general-purpose computer server 12 and one or more input devices 14 and output devices 16 directly attached to the computer server 12.

Computer processing system 10 is connected to a network 20. Computer processing system 10 communicates with a user 18 using input devices 14 and output devices 16. Input devices 14 include one or more of: a keyboard, a scanner, a mouse, trackball or another pointing device. Output devices 16 include one or more of a display or a printer. Computer processing system 10 communicates with network devices (not shown) over network 20. Network 20 can be a local area network (LAN), a wide area network (WAN), or the Internet.

Computer server 12 comprises: central processing unit (CPU) 22; network adapter 24; device adapter 26; bus 28 and memory 30.

CPU 22 loads machine instructions from memory 30 and performs machine operations in response to the instructions. Such machine operations include: increment or decrement a value in register (not shown); transfer a value from memory 30 to a register or vice versa; take instructions from a different location in memory if a condition is true or false (also known as a conditional branch instruction); and add or subtract the values in two different registers and put the result in another register. A typical CPU can perform many different machine operations. A set of machine instructions is called a machine code program, the machine instructions are written in a machine code language which is referred to a low level language. A computer program written in a high level language needs to be compiled to a machine code program before it can be run. Alternatively a machine code program such as a virtual machine or an interpreter can interpret a high level language in terms of machine operations.

Network adapter 24 is connected to bus 28 and network 20 for enabling communication between the computer server 12 and network devices. Device adapter 26 is connected to bus 28 and input devices 14 and output devices 16 for enabling communication between computer server 12 and user 18. In the case of transaction platforms the user would be an administrator. In the case of the applications the user could be an administrator or an end user.

Bus 28 couples the main system components together including memory 30 to CPU 22. Bus 28 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Memory 30 includes computer system readable media in the form of volatile memory 32 and non-volatile or persistent memory 34. Examples of volatile memory 32 are random access memory (RAM) 36 and cache memory 38. Generally volatile memory is used because it is faster and generally non-volatile memory is used because it will hold the data for longer. Computer processing system 10 may further include other removable and/or non-removable, volatile and/or non-volatile computer system storage media. By way of example only, persistent memory 34 can be provided for reading from and writing to a non-removable, non-volatile magnetic media (not shown and typically a magnetic hard disk or solid-state drive). Although not shown, further storage media may be provided including: an external port for removable, non-volatile solid-state memory; and an optical disk drive for reading from or writing to a removable, non-volatile optical disk such as a compact disk (CD), digital video disk (DVD) or Blu-ray. In such instances, each can be connected to bus 28 by one or more data media interfaces. As will be further depicted and described below, memory 30 may include at least one program product having a set (for example, at least one) of program modules that are configured to carry out the functions of various embodiments.

In the some embodiments, the set of program modules configured to carry out the functions of the embodiments comprise: transaction platform 99 and application programs 100. Transaction platform 99 comprises: operating system 98; transaction manager 102; resource manager 104; and extended transaction controller 200. Further program modules that support various embodiments but are not shown including firmware, boot strap program, and support applications. Each of the operating system, support applications, other program modules, and program data or some combination thereof, may include an implementation of a networking environment.

Computer processing system 10 communicates with at least one network 20 (such as a local area network (LAN), a general wide area network (WAN), and/or a public network like the Internet) via network adapter 24. Network adapter 24 communicates with the other components of computer server 12 via bus 28. It should be understood that although not shown, other hardware and/or software components could be used in conjunction with computer processing system 10. Examples, include, but are not limited to: microcode, device drivers, redundant processing units, external disk drive arrays, redundant array of independent disks (RAID), tape drives, and data archival storage systems.

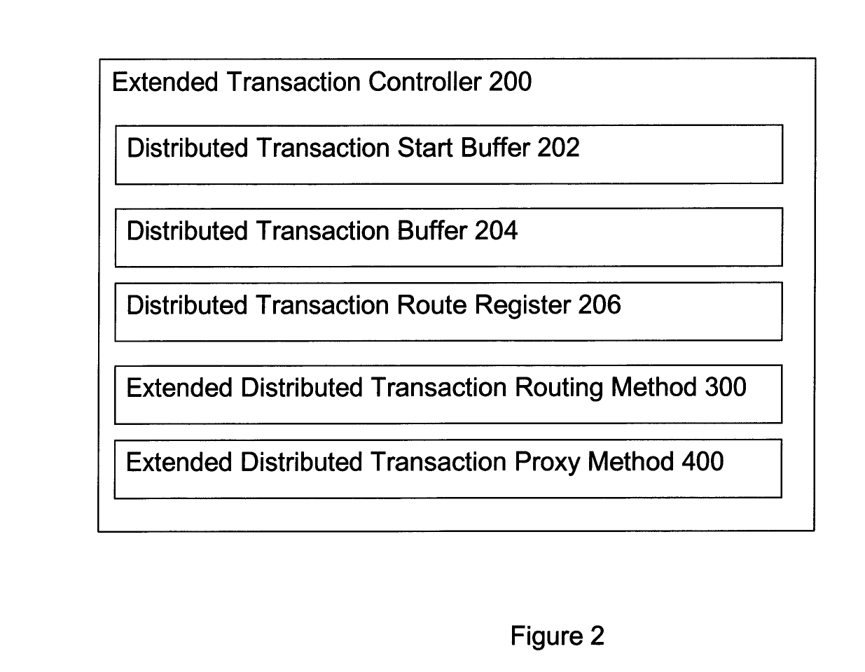

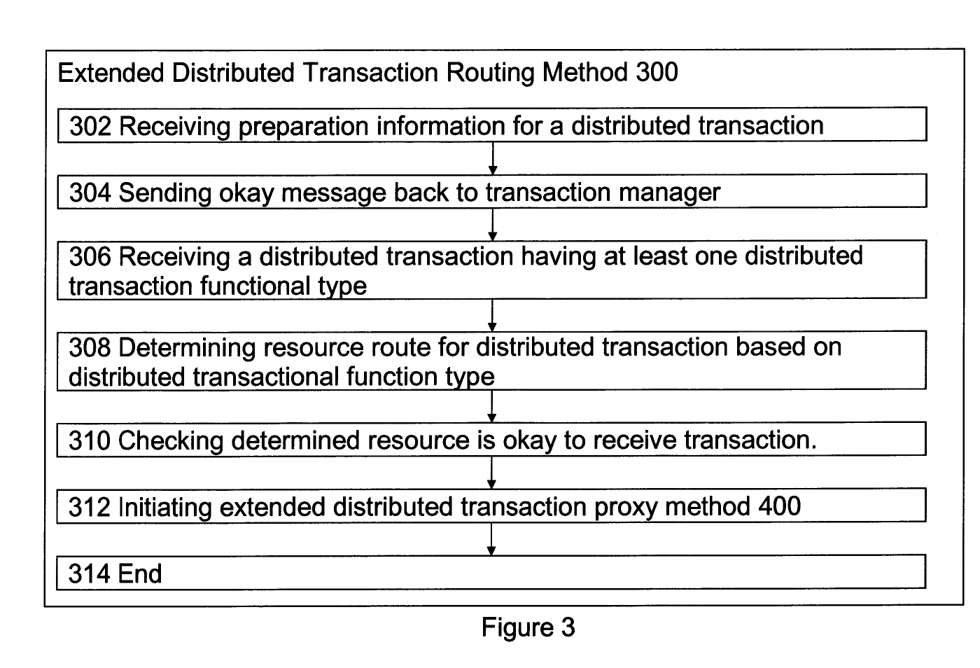

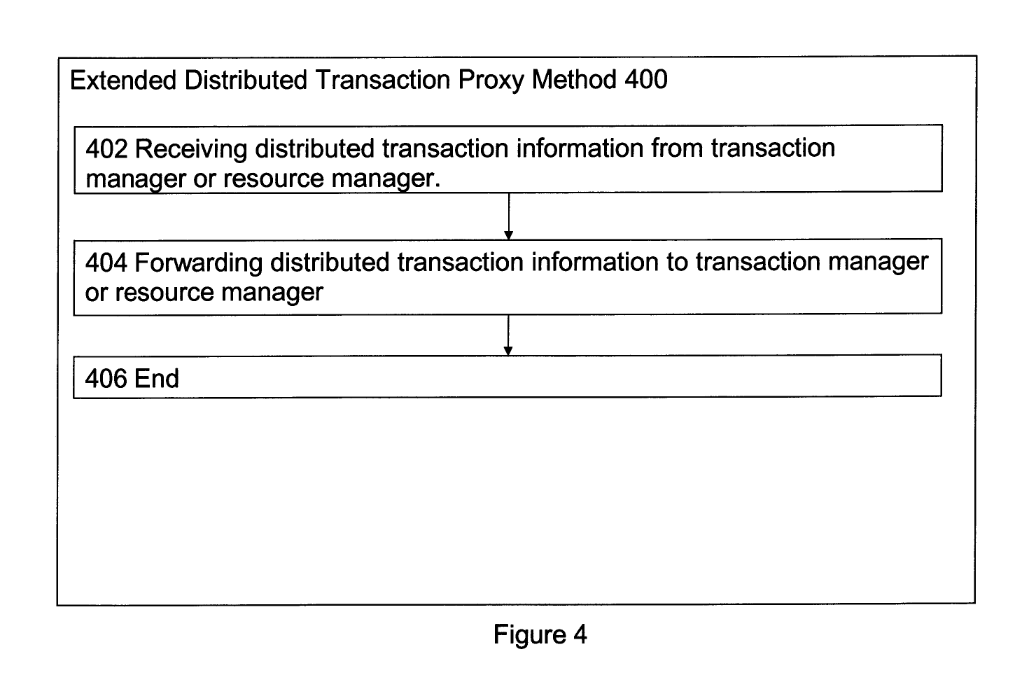

Referring to FIG. 2, extended transaction controller 200 comprises the following components: distributed transaction start buffer 202; distributed transaction buffer 204; distributed route register 206; extended distributed transaction routing method 300; and extended distributed transaction proxy method 400. Distributed transaction start buffer 202 is for storing transaction initiation information. Distributed transaction buffer 204 is for storing a received transaction after the initiation information is received. Distributed route register 206 is for storing a route or destination resource manager determined using the transaction information and in particular the function type of the transaction. Extended distributed transaction routing method 300 is for coordinating the determination of the resource manager and is explained in more detail with respect to FIG. 3 below. Extended distributed transaction proxy method 400 is for forwarding transaction messages to and from a resource manager and a transaction manager and is explained in more detail with respect to FIG. 4 below.

Referring to FIG. 3, extended distributed transaction routing method 300 comprises logical process blocks 302 to 314. Block 302 is for receiving preparation information for a distributed transaction from a transaction manager. Block 304 is for sending an okay message back to transaction manager. Block 306 is for receiving a distributed transaction having at least one distributed transaction functional type from the transaction manager. The functional type of the transaction is any characteristic of the transaction, for example, a financial transaction, an urgent transaction, a system transaction and subtypes thereof. The type may be a defined type identified in the transaction or an informal type identified by the extended distributed transaction routing method. Block 308 is for determining a resource route for the distributed transaction based on distributed transactional function type. Block 310 is for checking determined resource manager is okay to receive the transaction. Block 312 is for initiating extended distributed transaction proxy method 400 after the determined resource manager is okay to receive the transaction. Block 314 is the end of the method 300.

Referring to FIG. 4, extended distributed transaction proxy method 400 comprises logical process blocks 402 to 406. This method enables the extended transaction controller to become transparent in the distributed transaction system once a route has been determined. Block 402 is for receiving distributed transaction information from transaction manager or resource manager. Block 404 is for forwarding distributed transaction information to the appropriate transaction manager or resource manager without any further interaction. Block 406 is the end of the method 400.

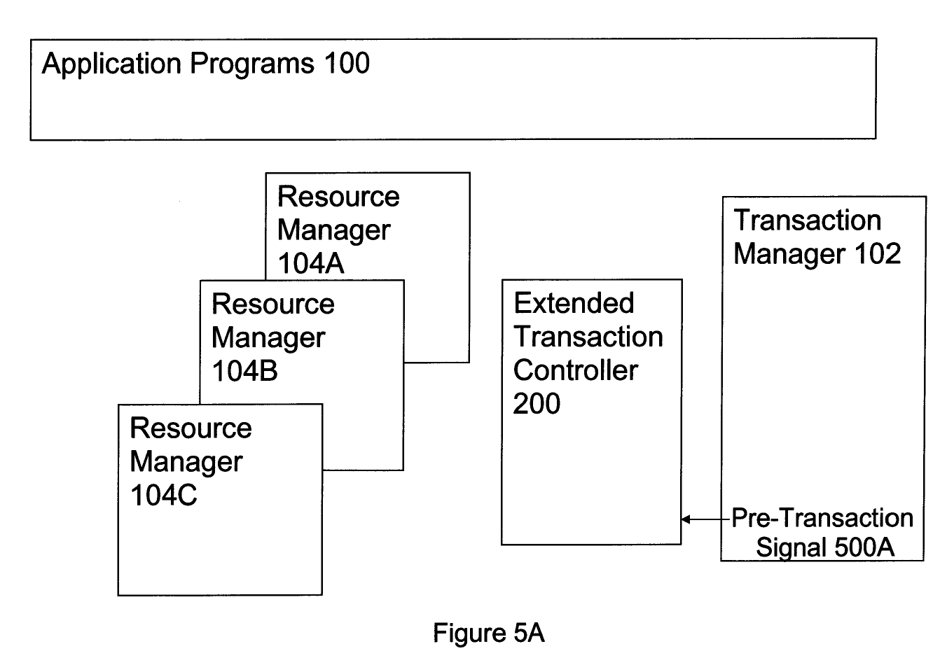

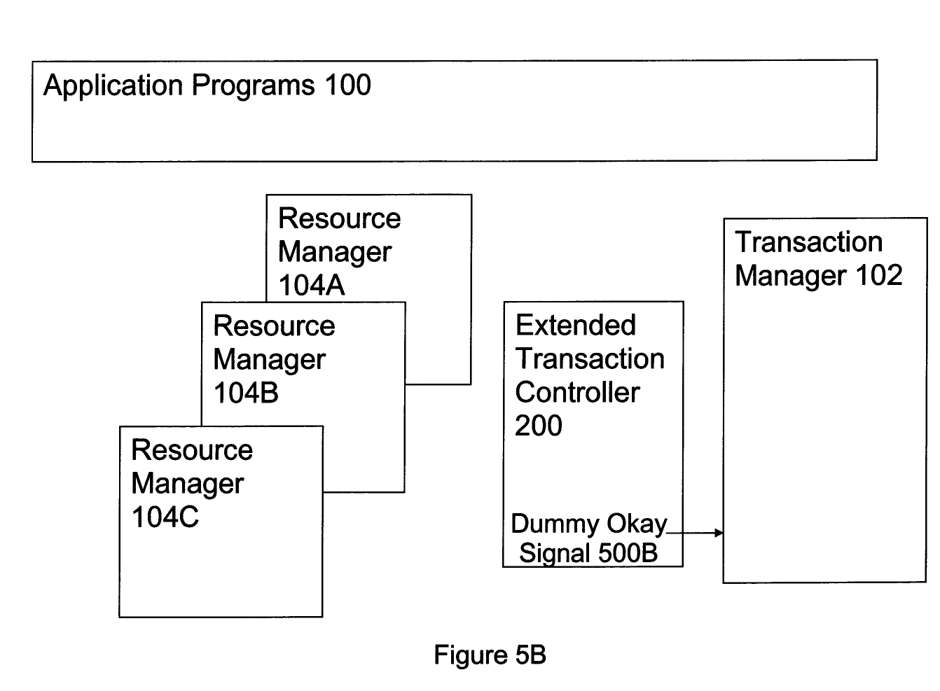

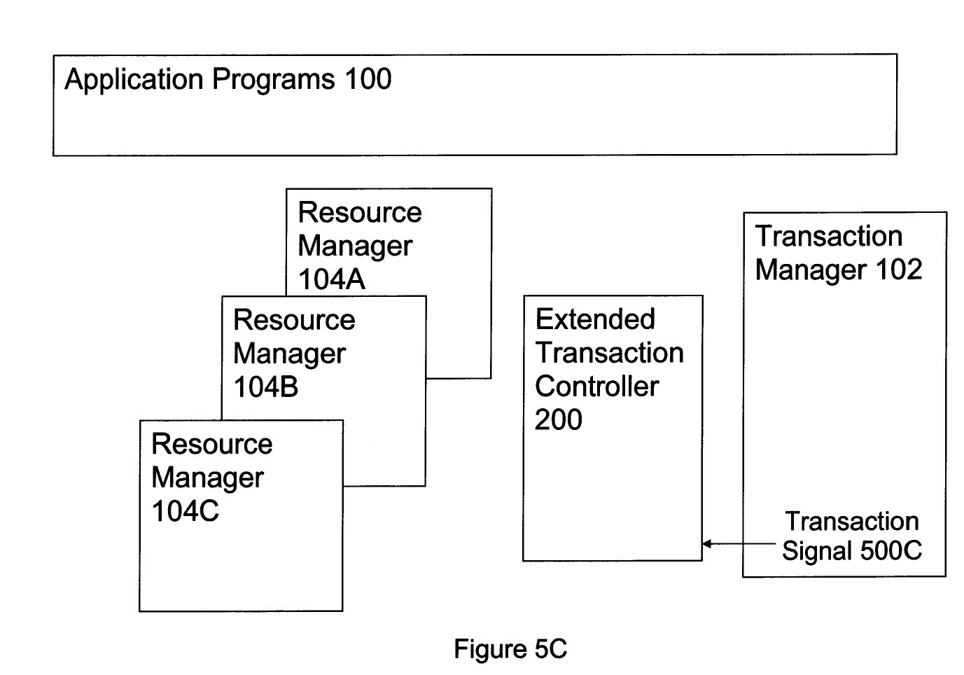

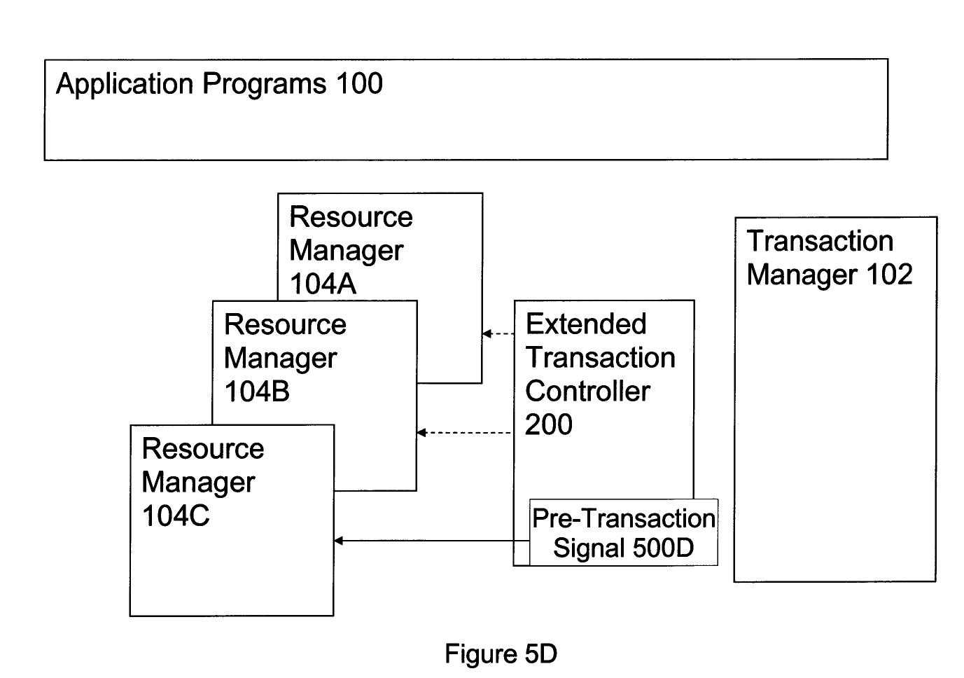

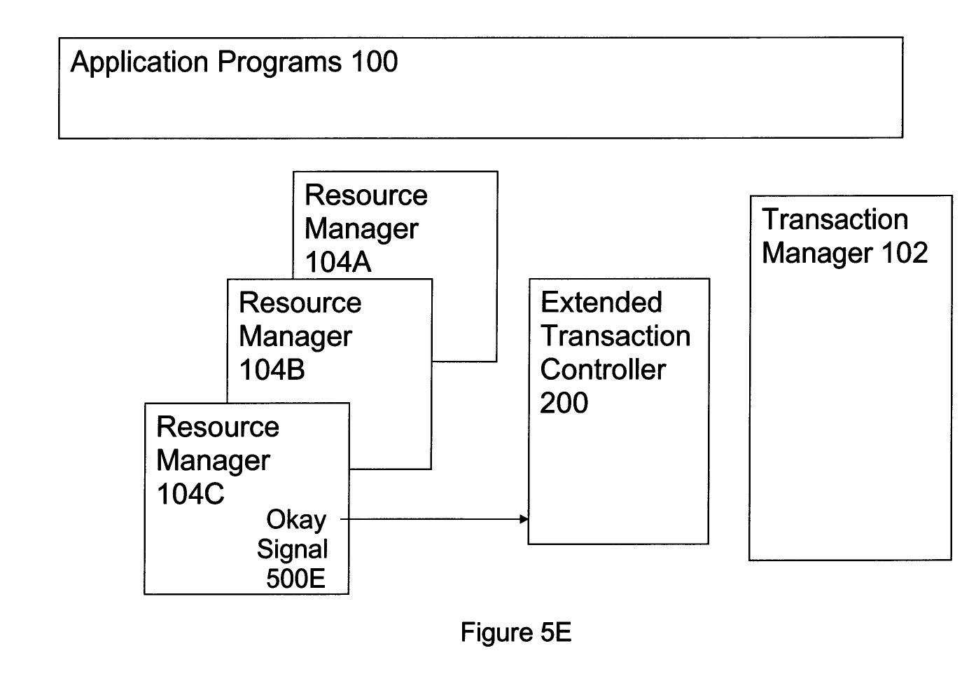

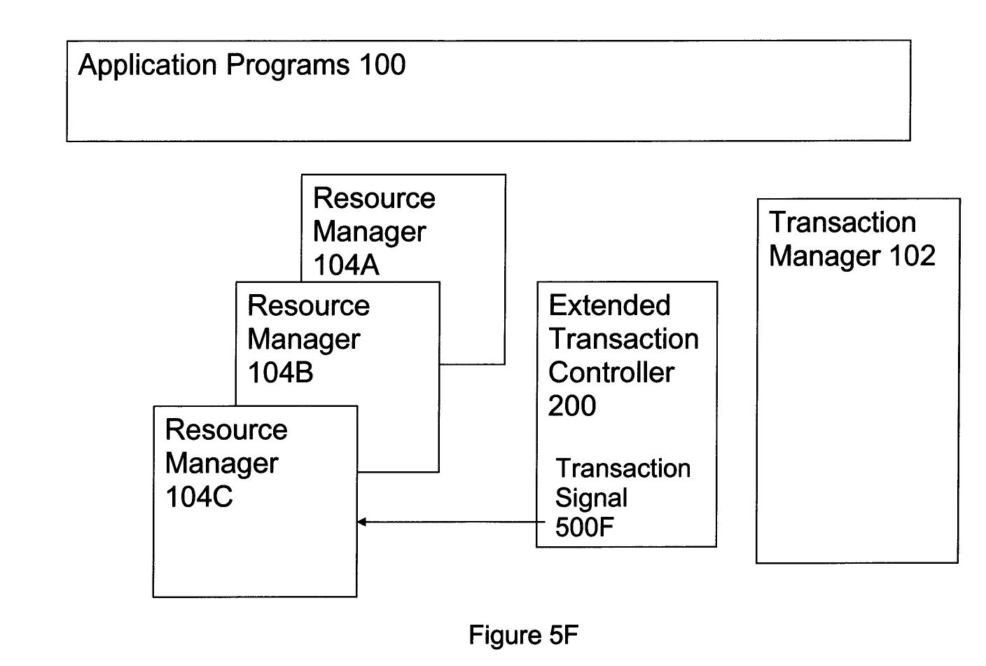

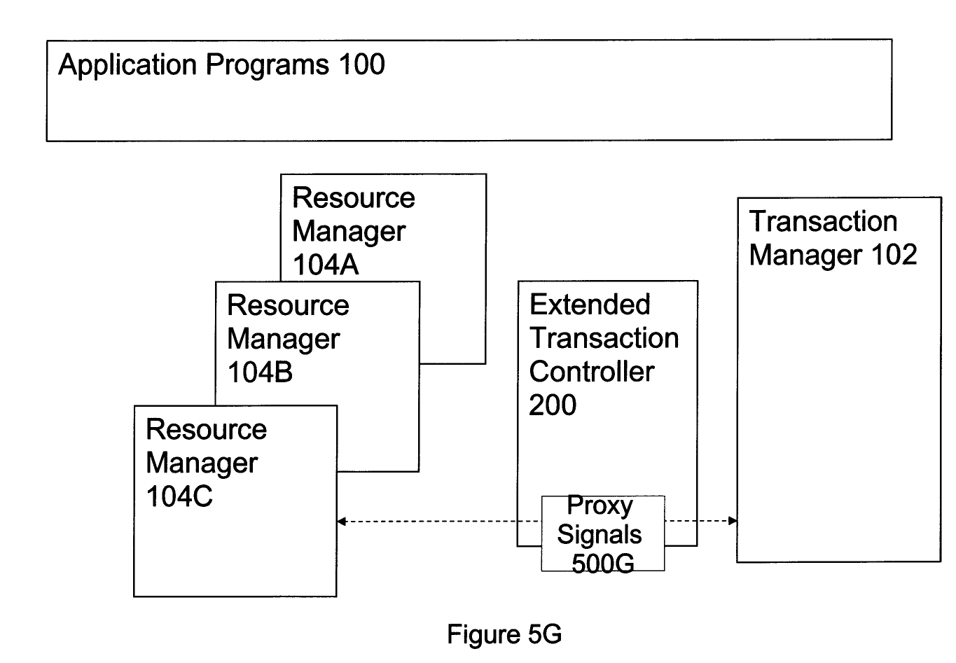

Referring to FIG. 5A to 5G, example transactions signals (500A to 500G) of an embodiment are described for a single distributed transaction sent to the extended transaction controller 200. Pre-transaction signal 500A is sent from transaction manager 102 to extended transaction controller 200 (FIG. 5A). Extended transaction controller 200 responds with a dummy okay signal 500B for the transaction manager 102 (FIG. 5B). Transaction manager 102 responds with a transaction signal 500C back to extended transaction controller 200 (FIG. 5C). The transaction is a US dollar transaction. Extended transaction controller 200 determines resource manager 104C and sends re-transaction signal 500D to resource manager 104C (FIG. 5D). In this example, resource manager 104C has been chosen because the example transaction is a US dollar transaction and resource manager 104C is better suited for US dollar transactions. Of course, any of resource manager 104B or 104A could have been more suitable. Resource manager 104C responds to extended transaction controller 200 with okay signal 500E (FIG. 5E). Extended transaction controller 200 sends the transaction (previously transaction signal 500C, now transaction signal 500F) to the resource manager 104C for processing (FIG. 5F). Extended transaction controller 200 acts as a proxy device and sends and receives signals between the determined resource manager 104C and the transaction manager without further delaying or routing (FIG. 5G). Therefore a response from resource manager 104C gets sent straight back to transaction manager 102.

Further embodiments are now described. It will be clear to one of ordinary skill in the art that all or part of the logical process blocks of the some embodiments may be alternatively embodied in a logic apparatus, or a plurality of logic apparatus, comprising logic elements arranged to perform the logical process blocks of the method and that such logic elements may comprise hardware components, firmware components or a combination thereof.

It will be equally clear to one of skill in the art that all or part of the logic components of some embodiments may be alternatively embodied in logic apparatus comprising logic elements to perform the blocks of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

Embodiments may be realized in the form of a computer implemented method of deploying a service comprising blocks of deploying computer program code operable to, when deployed into a computer infrastructure and executed thereon, cause the computer system to perform all the blocks of the method.

It will be appreciated that the method and components of the some embodiments may alternatively be embodied fully or partially in a parallel computing system comprising two or more processors for executing parallel software.

It will be clear to one skilled in the art that many improvements and modifications can be made to the foregoing exemplary embodiment without departing from the scope of the present invention.

In a first aspect, there is provided a system for routing a distributed transaction comprising: a first buffer for receiving and storing distributed transaction initiation information from a transaction manager; a second buffer for receiving a distributed transaction having at least one function type from the transaction manager; and a transaction engine for sending an okay message to the transaction manager on receipt of transaction initiation information, for determining a resource manager for the distributed transaction based on the functional type of the distributed transaction, and for sending, if the resource manager is ready, the distributed transaction to the determined resource manager.

In a second aspect, there is provided a method for routing a distributed transaction comprising: receiving and storing distributed transaction initiation information from a transaction manager; sending an okay message to the transaction manager; receiving a distributed transaction having at least one function type from the transaction manager; determining a resource manager for the distributed transaction based on the functional type of the distributed transaction; and sending, if the resource manager is ready, the distributed transaction to the determined resource manager. The embodiments delay sending distributed transaction information initiation information to a resource manager until the full distributed transaction is received and a route has been determined for the transaction. The method further comprises determining if the resource manager is ready by sending the distributed transaction initiation information to the resource manager and waiting for an okay message. The method further comprises, once the resource manager has been confirmed, forwarding related transaction messages from the transaction manager to the resource manager and vice versa.

The distributed transaction system uses extended architecture (XA) protocol. The embodiments combine the information provided by the XA protocol with the existing information about the work that will be done within the transaction. This provides a greater set of information about the transaction that can be used to decide where to route the transaction.

The distributed transaction initiation information comprises an XA_Start signal. The XA_Start signal that precedes the main transaction information is received by the extended routing process and stored rather than being routed immediately to a resource manager. When the main transactional work arrives, the information about it and the preceding XA information are combined to provide the routing decision.

Advantageously, the resource route for the global transaction is determined based the availability of the allocated resources for that function type. The embodiments improve the method of making the decision to route an XA transaction. Should the target server be unavailable then the XA start and the transaction can be sent to a different region without problem as no transaction work has been started.

The embodiments have a real effect on speed of transaction processing carried on outside the computer extended transaction controller because transactions are routed in a determined way for increased efficiency of the overall transaction system. The faster effect operates at the operating system level of the computer below any applications.

The computer program product comprises a series of computer-readable instructions either fixed on a tangible medium, such as a computer readable medium, for example, optical disk, magnetic disk, solid-state drive or transmittable to a computer system, using a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM (Read Only Memory) or fixed disk, or distributed from a server or electronic bulletin board over a network, for example, the Internet or World Wide Web.

In a fifth aspect, there is provided a data carrier aspect of an embodiment that comprises functional computer data structures to, when loaded into a computer system and operated upon thereby, enable said computer system to perform all the blocks of the method. A suitable data-carrier could be a solid-state memory, magnetic drive or optical disk. Channels for the transmission of data may likewise comprise storage media of all descriptions as well as signal-carrying media, such as wired or wireless signal-carrying media.

It will be clear to one of ordinary skill in the art that all or part of the method of various embodiments may suitably and usefully be embodied in additional logic apparatus or additional logic apparatuses, comprising logic elements arranged to perform the blocks of the method and that such logic elements may comprise additional hardware components, firmware components or a combination thereof.

It will be equally clear to one of skill in the art that some or all of the functional components of various embodiments may suitably be embodied in alternative logic apparatus or apparatuses comprising logic elements to perform equivalent functionality using equivalent method blocks, and that such logic elements may comprise components such as logic gates in, for example a programmable logic array or application-specific integrated circuit. Such logic elements may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

Various embodiments may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, using a modem or other interface device, over either a tangible medium, including but not limited to optical or analogue communications lines, or intangibly using wireless techniques, including but not limited to microwave, infra-red or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infra-red, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

Various embodiments may be realized in the form of a computer implemented method of deploying a service comprising blocks of deploying computer program code operable to, when deployed into a computer infrastructure and executed thereon, cause the computer system to perform all the blocks of the method.

Various embodiments may be realized in the form of a data carrier having functional data thereon, said functional data comprising functional computer data structures to, when loaded into a computer system and operated upon thereby, enable said computer system to perform all the blocks of the method.

It will be clear to one skilled in the art that many improvements and modifications can be made to the foregoing exemplary embodiment without departing from the scope of the present invention.

What is claimed is:

1. A system for routing a distributed transaction comprising:
a first buffer for receiving and storing distributed transaction initiation information from a transaction manager;
a second buffer for receiving a distributed transaction having at least one function type from the transaction manager; and
a transaction engine for sending an okay message to the transaction manager on receipt of transaction initiation information, for determining a resource manager for the distributed transaction based on the function type of the distributed transaction, and for sending, based on the resource manager being ready, the distributed transaction to the determined resource manager.

2. The system according to claim 1, wherein the transaction engine is configured to determine that the resource manager is ready by sending the distributed transaction initiation information to the resource manager and waiting for a corresponding okay message.

3. The system according to claim 1, wherein the transaction engine is configured to, based on the resource manager being ready, forwarding related transaction messages from the transaction manager to the resource manager, and forwarding related transaction messages from the resource manager to the transaction manager.

4. The system according to claim 1, wherein the distributed transaction system uses extended architecture (XA) protocol.

5. The system according to claim 1, wherein initiation information for the distributed transaction comprises an XA_Start transaction.

6. The system according to claim 1, further comprising determining a resource route for a global transaction based on availability of an allocated resources for a function type of the global transaction.

7. A method for routing a distributed transaction comprising:
receiving and storing distributed transaction initiation information from a transaction manager;
sending an okay message to the transaction manager;
receiving a distributed transaction having at least one function type from the transaction manager;
determining a resource manager for the distributed transaction based on the function type of the distributed transaction; and
sending, based on the resource manager being ready, the distributed transaction to the determined resource manager.

8. The method according to claim 7, further comprising determining that on the resource manager being ready by sending the distributed transaction initiation information to the resource manager and waiting for an okay message.

9. The method according to claim 7, further comprising, based on the resource manager being ready, forwarding related transaction messages from the transaction manager to the resource manager, and forwarding related transaction messages from the resource manager to the transaction manager.

10. The method according to claim 7, wherein the distributed transaction uses extended architecture (XA) protocol.

11. The method according to claim 10, wherein the initiation information for the distributed transaction comprises a XA_Start transaction.

12. The method according to claim 7, further comprising determining a resource route for a global transaction based on availability of an allocated resources for a function type of the global transaction.

13. A computer program product for routing a distributed transaction, the computer program product comprising a computer readable medium having computer-readable program code embodied therewith, which when executed by a computer processor, causes the computer processor to implement:
receiving and storing distributed transaction initiation information from a transaction manager;
sending an okay message to the transaction manager;
receiving a distributed transaction having at least one function type from the transaction manager;
determining a resource manager for the distributed transaction based on the function type of the distributed transaction; and
sending, based on the resource manager being ready, the distributed transaction to the determined resource manager.

14. The computer program product according to claim 13, further comprising determining that on the resource manager being ready by sending the distributed transaction initiation information to the resource manager and waiting for an okay message.

15. The computer program product according to claim 13, further comprising, based on the resource manager being ready, forwarding related transaction messages from the transaction manager to the resource manager, and forwarding related transaction messages from the resource manager to the transaction manager.

16. The computer program product according to claim 13, wherein the distributed transaction uses extended architecture (XA) protocol.

17. The computer program product according to claim 16, wherein the initiation information for the distributed transaction comprises a XA_Start transaction.

18. The computer program product according to claim 13, further comprising determining a resource route for a global transaction based on availability of an allocated resources for a function type of the global transaction.
